(19) United States
(12) Patent Application Publication
(10) Pub. No.: US 2026/0105754 A1
(43) Pub. Date: Apr. 16, 2026

(54) METHOD AND DEVICE FOR IMAGE PROCESSING FOR DEFECTIVE-MULTI CHANNEL IMAGE

(71) Applicants: HYUNDAI MOTOR COMPANY, Seoul (KR); KIA CORPORATION, Seoul (KR)

(72) Inventors: Yoon Ji KIM, Gyeonggi-do (KR); Jong Hyun CHOI, Gyeonggi-do (KR)

(73) Assignees: HYUNDAI MOTOR COMPANY, Seoul (KR); KIA CORPORATION, Seoul (KR)

(21) Appl. No.: 19/342,329

(22) Filed: Sep. 26, 2025

(30) Foreign Application Priority Data
Oct. 14, 2024 (KR) 10-2024-0139299

(51) Int. Cl. G06V 20/56; B60W 60/00; G06T 7/00; G06T 7/50; G06V 10/764

(52) U.S. Cl. CPC G06V 20/56; B60W 60/001; G06T 7/0002; G06T 7/50; G06V 10/764; G06T 2207/20081

(57) ABSTRACT

In a method and device for image processing for defective multi-channel image, the method includes: obtaining the defective multi-channel image and a normal multi-channel image as learning data from a multi-channel image obtained from a vehicle; identifying a defective channel of the defective multi-channel image to generate fault ground truth data from ground truth data corresponding to the defective multi-channel image, and provide normal ground truth data corresponding to the normal multi-channel image; and training an image processing model using the learning data, the fault ground truth data, and the normal ground truth data.

### CROSS-REFERENCE TO RELATED APPLICATION

The present application claims priority to and the benefit of Korean Patent Application No. 10-2024-0139299, filed on Oct. 14, 2024, the present disclosure of which is incorporated herein by reference in its entirety.

### BACKGROUND

### Field of the Present Disclosure

The present disclosure relates to a learning method and device for image processing for a defective multi-channel image, and to a learning method and device for image processing that guarantees output stability of a learning-based image processing model without performance degradation even based on a multi-channel image including some defects.

### Discussion of Related Art

Recently, vehicles with an autonomous driving function have been commercialized for convenience of driving. The autonomous driving function is being developed to allow a vehicle to control a driving operation as much as possible without driver intervention. In autonomous driving, perception for detecting a surrounding environment and estimating a location of a vehicle, a determination of a driving operation based on the perceived environment and estimated location, and control of an actuator in accordance with the determined operation can be processed.

The surrounding environment may be perceived from data such as images from sensors mounted on the vehicle, and these images may be used to estimate object detection information, semantic segmentation information, and depth information using computer vision technology. The vehicle may include a plurality of cameras that capture images from different directions to obtain various images of surroundings. To recognize an area around the vehicle without omission, the adjacent cameras among the plurality of cameras may be disposed to have partially overlapping shooting ranges. Meanwhile, a learning model for inferring the information may receive and use a multi-channel image obtained from the plurality of cameras as a single input. For the accuracy of the inference, it is necessary for each camera not to fail or for a multi-channel image obtained from the plurality of cameras to be provided to the learning model normally without any defects.

However, when some of the plurality of cameras fail or a portion of the multi-channel image has a failure or fault, such failure or fault affects an output of the learning model. Defective images output from some defective channels of a multi-channel camera are poor or do not allow objects to be recognized. The learning model may receive all images of respective channels and overlapping images of some overlapping channels as a single input, and output result data according to a predetermined task. The defective image may also have an image obtained only from a defective channel and an overlapping image that overlaps images of adjacent channels.

The learning model does not generate a local task result based on a unique image of a defective channel, but may output a local task result based on an overlapping image that includes a defective image of the defective channel. The task result based on the overlapping image with the defective image may be generated with an error. Accordingly, result data in which local task results are combined also has a fault, which may cause a fatal error in a determination and control of autonomous driving.

### BRIEF SUMMARY

According to various aspects of the present disclosure, the present disclosure is directed to providing a learning method and device for image processing that guarantees output stability of a learning-based image processing model without performance degradation even with a multi-channel image having some defects.

According to various aspects of the present disclosure, the objects to be achieved in an exemplary embodiment of the present disclosure are not limited to the objects mentioned above, and other objects that are not mentioned can be clearly understood by those skilled in the art to which the present disclosure belongs from the description below.

According to various aspects of the present disclosure, there is provided a learning method for image processing for a defective multi-channel image, the method including: obtaining the defective multi-channel image and a normal multi-channel image as learning data from a multi-channel image obtained from a vehicle; identifying a defective channel of the defective multi-channel image to generate fault ground truth data from ground truth data corresponding to the defective multi-channel image, and provide normal ground truth data corresponding to the normal multi-channel image; training an image processing model using the learning data, the fault ground truth data, and the normal ground truth data; and transmitting the image processing model to the vehicle. The image processing model is executed by a processor of the vehicle, and the vehicle is controlled based on data output from the image processing model.

According to various aspects of the present disclosure in the method, the defective multi-channel image may be generated by processing, into an object non-detection image, an image designated as a defective channel among image channels of an abnormal multi-channel image selected from the multi-channel image.

According to various aspects of the present disclosure in the method, the multi-channel image may be a set of images obtained from image channels set for a plurality of cameras disposed on the vehicle, and the defective channel may be designated as one of a plurality of image channels.

According to various aspects of the present disclosure in the method, the normal multi-channel image and the defective multi-channel image may be classified through equal distribution of the multi-channel image, and the defective multi-channel image may be generated equally for the plurality of image channels.

According to various aspects of the present disclosure in the method, the defective multi-channel image may be generated by blackout processing for an image of the defective channel in the abnormal multi-channel image.

According to various aspects of the present disclosure in the method, the fault ground truth data may be generated by processing the ground truth data corresponding to a unique image area of the defective channel into an unrecognized state, and the unique image area may be a non-overlapping image area recognized only in the defective channel other than an overlapping image area between the defective channel and a normal channel adjacent to the defective channel.

According to various aspects of the present disclosure in the method, the fault ground truth data may be generated by blackout processing for the ground truth data corresponding to the unique image area.

According to various aspects of the present disclosure in the method, when the image processing model includes depth estimation, the fault ground truth data may be generated by masking processing for setting a depth value to null in the ground truth data corresponding to the unique image area.

According to various aspects of the present disclosure in the method, the training of the image processing model may include training the image processing model using a fault loss function related to the fault ground truth data and a normal loss function related to the normal ground truth data, and the fault loss function may be established as a loss function in which an object belonging to the ground truth data corresponding to the unique image area is excluded and an object belonging to the ground truth data corresponding to an image area of the normal channel is considered.

According to various aspects of the present disclosure in the method, the training of the image processing model may include processing learning for the defective multi-channel image using the overlapping image area obtained through the normal channel adjacent to the defective channel.

According to another exemplary embodiment of the present disclosure, there is provided a learning device for image processing for a defective multi-channel image, the device including: a memory storing at least one instruction; and a processor configured to execute the at least one instruction stored in the memory. The processor is configured to obtain the defective multi-channel image and a normal multi-channel image as learning data from a multi-channel image obtained from a vehicle; identify a defective channel of the defective multi-channel image to generate fault ground truth data from ground truth data corresponding to the defective multi-channel image, and provide normal ground truth data corresponding to the normal multi-channel image; train an image processing model using the learning data, the fault ground truth data, and the normal ground truth data; and transmit the image processing model to the vehicle. The image processing model is executed by a processor of the vehicle, and the vehicle is controlled based on data output from the image processing model.

The features briefly summarized above for the present disclosure are only exemplary aspects of the detailed description of the present disclosure which follow, and are not intended to limit the scope of the present disclosure.

The technical problems solved by the present disclosure are not limited to the above technical problems and other technical problems which are not described herein will be clearly understood by a person (hereinafter referred to as an ordinary technician) including ordinary skill in the technical field, to which the present disclosure belongs, from the following description.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating an example in which a learning device according to an exemplary embodiment of the present disclosure communicates with a vehicle to transmit and receive data to or from the vehicle;

FIG. 2 is a diagram schematically illustrating modules forming the learning device according to an exemplary embodiment of the present disclosure;

FIG. 3 is a diagram illustrating modules forming the vehicle;

FIG. 4 is a flowchart illustrating a learning method for image processing for a defective multi-channel image according to another exemplary embodiment of the present disclosure;

FIG. 5 is a diagram illustrating a view area in a multi-channel camera of the vehicle;

FIG. 6 is a diagram illustrating the defective multi-channel image;

FIG. 7 is a diagram illustrating an example in which fault ground truth data is generated;

FIG. 8 is a diagram illustrating another example in which the fault ground truth data is generated;

FIG. 9 is a diagram illustrating an object belonging to a unique image area of a defective channel; and

FIG. 10 is a diagram illustrating training of an image processing model.

### DETAILED DESCRIPTION OF EXEMPLARY EMBODIMENTS

Hereinafter, various exemplary embodiments of the present disclosure will be described in detail with reference to the accompanying drawings so that those skilled in the art may easily implement the present disclosure. However, the present disclosure may be implemented in various different ways, and is not limited to the exemplary embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In an exemplary embodiment of the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. Furthermore, when an element “includes” or “has” another element, this means that one element may further include another element without excluding another component unless stated otherwise.

In an exemplary embodiment of the present disclosure, the terms first, second, etc. are only used to distinguish one element from another and do not limit the order or the degree of importance between the elements unless specifically mentioned. Accordingly, a first element in an exemplary embodiment could be termed a second element in another exemplary embodiment of the present disclosure, and similarly, a second element in an exemplary embodiment could be termed a first element in another exemplary embodiment of the present disclosure, without departing from the scope of the present disclosure.

In an exemplary embodiment of the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In an exemplary embodiment of the present disclosure, elements described In various embodiments do not necessarily mean essential elements, and some thereof may be optional elements. Therefore, an exemplary embodiment including a subset of elements described in an exemplary embodiment of the present disclosure is also included in the scope of the present disclosure. Furthermore, various exemplary embodiments including other elements in addition to the elements described in the various exemplary embodiments of the present disclosure are also included in the scope of the present disclosure.

The advantages and features of the present disclosure and the way of attaining them will become apparent with reference to various exemplary embodiments described below in detail in conjunction with the accompanying drawings. Embodiments, however, may be embodied in various forms and should not be constructed as being limited to example embodiments set forth herein. Rather, these embodiments are provided so that the present disclosure will be complete and will fully convey the scope of the present disclosure to those skilled in the art.

In the present disclosure, each of phrases such as “A or B”, “at least one of A and B”, “at least one of A or B”, “A, B or C”, “at least one of A, B and C”, ““at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, various exemplary embodiments of the present disclosure will be described with reference to the accompanying drawings.

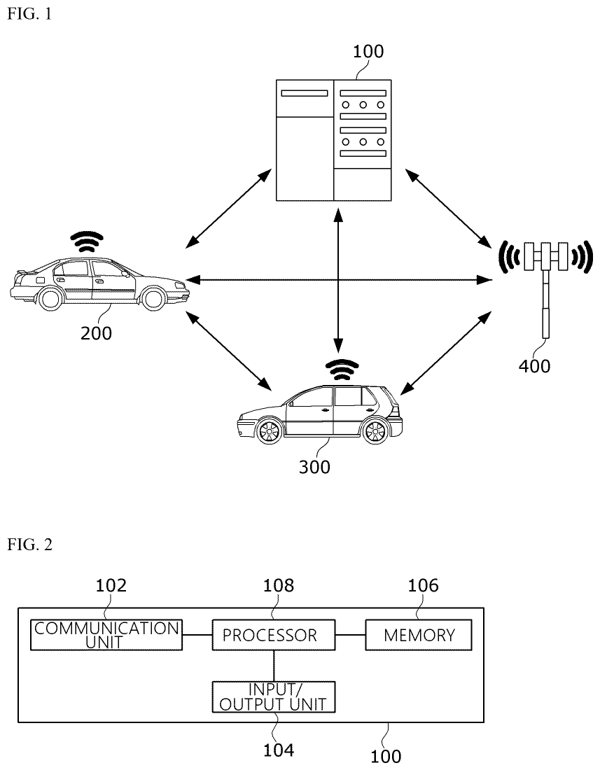

Hereinafter, a learning device implementing a learning method for image processing for a defective multi-channel image according to an exemplary embodiment of the present disclosure, and a vehicle that receives an image processing model distributed by the learning device will be described with reference to FIG. 1 and FIG. 2. The vehicle may receive the image processing model trained by the learning device, and execute various driving assistance processes using the model. FIG. 1 is a diagram illustrating an example in which the learning device according to the exemplary embodiment of the present disclosure communicates with the vehicle to transmit and receive data to or from the vehicle.

Referring to FIG. 1, a learning device 100 may train an image processing model that is configured to perform at least one task using multi-channel images obtained from vehicles 200 and 300 and distribute the trained image processing model to the vehicles 200 and 300. The learning device 100 may receive feedback resulting from the execution of the image processing model from the vehicles 200 and 300, update the image processing model, and transmit the updated image processing model to the vehicles 200 and 300.

The image processing model may include a single bird's eye view (BEV) network that receives a multi-channel image as an input and processes a task of generating a BEV. Here, the network is a learning model that is trained by machine learning to perform a task, and in the present disclosure, “network” can have substantially the same meaning as “learning model” and “network model.” The single BEV network may be a model in which all the images of the channels are input to a single network, instead of a plurality of networks for processing images of respective channels among multiple channels being included. The vehicle 200 may include a camera as an image sensor. The vehicle 200 may include a plurality of cameras that are directed in different directions to obtain a surrounding environment. In an exemplary embodiment of the present disclosure, each camera may be referred to as an image channel, and a multi-channel image may be a set of images obtained from image channels set for the plurality of cameras. The BEV network may use an encoder-decoder that utilizes an appropriate neural network, such as a convolutional layer, a multi-perceptron layer (MLP), and a projection layer. The BEV network is not limited to the above-described example, and may be implemented as any type of learning model.

Furthermore, the image processing model may include at least one network that processes a task of inferring an object of an image based on the multi-channel image. The inferring task may include at least one of a task of classifying an object, a semantic segmentation task of estimating a type of an object for each pixel, and a task of estimating a depth of the object, for example. The image processing model may include a network for each of the above-described inferring tasks. To perform the inferring task, the image processing model may include a combination of the BEV network and the network of the inferring task. For example, a BEV generated from the BEV network may be input to the network of the inferring task, and the inferring task may generate output data according to the task based on the BEV. The network of the inferring task may use an encoder-decoder that utilizes an appropriate neural network, such as a convolutional layer, a multi-perceptron layer (MLP), and a pose network layer. The network of the inferring task is not limited to the above-described example, and may be implemented as any type of learning model.

The image processing model is built into the vehicle 200 to generate output data according to the task and process various types of driving support, such as autonomous driving, driving assistance, and driving control, based on the output data.

The vehicles 200 and 300 may be ground vehicles that drive on the ground. The vehicles 200 and 300 may be mobility apparatuses that are driven manually or autonomously. The autonomous vehicles 200 and 300 may be implemented with semi-autonomous driving or fully autonomous driving. The fully autonomous driving may be disposed as autonomous movement in which controllers of the vehicles 200 and 300 completely control driving without user intervention even when a driving situation is uncertain. The semi-autonomous driving may be disposed as autonomous movement in which driver intervention is required in some specific driving situations. The semi-autonomous driving may be implemented to allow the controllers of the vehicles 200 and 300 to deactivate autonomous driving when such situations occur and transfer control to a user, so that the user can perform manual driving. According to a level of autonomous driving defined by the Society of Automotive Engineers (SAE) in the US, semi-autonomous driving corresponds to autonomous driving levels 1 to 4, and fully autonomous driving corresponds to level 5.

The present disclosure is not limited to ground vehicles, and may be applied to various types of mobility apparatuses. For example, the mobility apparatuses may be air mobility apparatuses, mobile robots, water mobility apparatuses, and the like.

An ITS device 400 may be a type of external device, such as a roadside base station (roadside unit (RSU)). The ITS device 400 may exchange vehicle perception data, driving control and status data, environmental data of surroundings of the vehicle, map data, and the like with the vehicles 200 and 300 via a Vehicle-to-Infrastructure (V2I) to assist with driving of a user's vehicle or support autonomous driving of the vehicles 200 and 300. The vehicle 200 may exchange the above-described data with the other vehicle 300 via a Vehicle-To-Vehicle (V2V) to support manual driving or autonomous driving.

The vehicles 200 and 300 may communicate with other vehicles or other devices based on cellular communication, wireless access in vehicular environment (WAVE) communication, dedicated short range communication (DSRC), short-range communication, or another communication scheme.

For example, the vehicle 200 may use a cellular communication network such as LTE or 5G, a WiFi communication network, or a WAVE communication network for communication with the server configured as the learning device 100, the other vehicle 300, and the ITS device 400. As an exemplary embodiment of the present disclosure, DSRC used in the vehicle 200 may be used for communication between vehicles. A communication scheme among the server 100, the vehicle 200, the other vehicle 300, the ITS device 400, and a user device is not limited to the above-described embodiment.

Meanwhile, the learning device 100 may be, for example, a device such as a server disposed separately from the vehicles 200 and 300 to be operated by a vehicle manufacturer or a management agency that provides a driving service. When the learning device 100 is a server operated by the vehicle manufacturer or management agency that supports autonomous driving, the learning device 100 may receive connected data of the vehicles 200 and 300 or transmit data necessary for autonomous driving. The learning device 100 may transmit various types of information and software modules used for control of the vehicles 200 and 300 to the vehicles 200 and 300 in response to a request and data transmitted from the vehicles 200 and 300 and the user device to support driving of the vehicles 200 and 300 and various services. In an exemplary embodiment of the present disclosure, functions of the learning device 100 related to the learning method according to the exemplary embodiment of the present disclosure will be mainly described with reference to FIG. 2.

FIG. 2 is a diagram schematically illustrating modules forming the learning device according to an exemplary embodiment of the present disclosure.

The learning device 100 may include a communication unit 102, an input/output unit 104, a memory 106, and a processor 108. The communication unit 102 may support mutual communication with the vehicles 200 and 300, the ITS device 400, and the like. In an exemplary embodiment of the present disclosure, the communication unit 102 may receive various types of data and networks (or algorithms) used to train a learning model that supports driving and convenience functions of the vehicle 200. The communication unit 102 may be a communication interface that transmits information and a network related to the learning model to the vehicle 200. Furthermore, the communication unit 102 may be a communication module that receives data generated or stored while driving from the vehicle 200. The communication unit 102 may be a communication module that transmits information that supports driving, such as map information, environmental information for recognizing objects around the vehicle 200, traffic information, weather information, and the like, to the vehicle 200. The communication unit 102 may be a communication module that transmits applications related to driving and convenience functions.

The input/output unit 104 may be an interface that receives an input command from a manager and provides a processing result according to the command. Furthermore, the input/output unit 104 may provide intermediate data and final data according to the training of the learning model used in the vehicle 200.

The memory 106 may store a program and various types of data for control of the learning device 100, and load the program or read and record the data in response to a request from the processor 108. The memory 106 may manage learning data that is used for training of the image processing model. The learning data may include a multi-channel image collected from a plurality of vehicles 200 and 300 and/or a typical DB for learning data, ground truth data corresponding to an output of the image processing model, and the like. The memory 106 may also hold an application for implementing driving and convenience functions of the vehicles 200 and 300, map information, traffic information, weather information, and various types of other information affecting driving, in addition to the above-described data.

The processor 108 may perform overall control of the learning device 100. The processor 108 may be configured to execute applications and instructions stored in the memory 106. The processor 108 may be configured for controlling the learning device 100 so that the learning device 100 trains the image processing model stored in the memory 106 using the learning data described above, and distributes (or transmits) the trained learning model to the vehicles 200 and 300.

The processor 108 may be configured to determine learnable parameters for constructing the image processing model through training. The learnable parameters may be, for example, a filter forming a task network in the image processing model, a weight of an MLP layer, and a factor of a projection layer.

The processor 108 may execute processing for obtaining a defective multi-channel image and a normal multi-channel image as learning data from multi-channel images obtained from the vehicles 200 and 300. The processor 108 may perform processing for identifying defective channels of the defective multi-channel image to generate fault ground truth data from ground truth data corresponding to the defective multi-channel image and provide normal ground truth data corresponding to the normal multi-channel image. The processor 108 may implement processing for training the image processing model using learning data including the defective multi-channel image and the normal multi-channel image, the fault ground truth data, and the normal ground truth data.

Furthermore, the processor 108 may perform processing for supporting driving and convenience functions of the vehicles 200 and 300. In an exemplary embodiment of the present disclosure, the processor 108 may be implemented as a single processing module, for example. In an exemplary embodiment of the present disclosure, the processing according to the above-described matters may be distributed and processed in a plurality of processing modules, which may be collectively referred to as the processor 108 in an exemplary embodiment of the present disclosure.

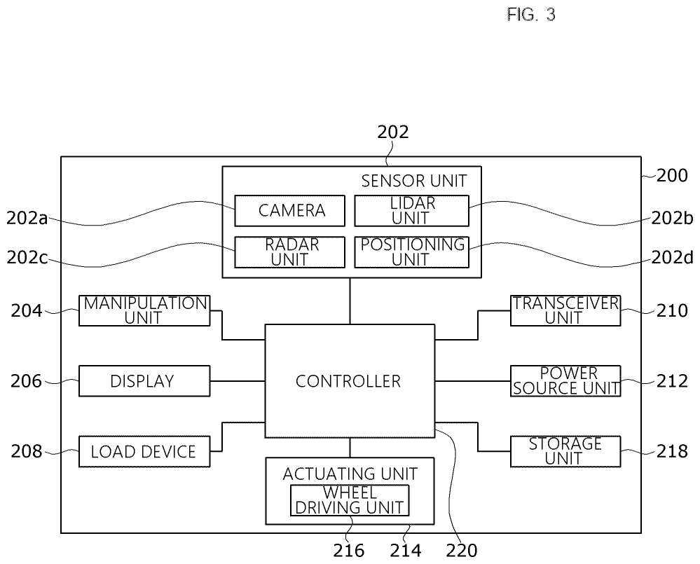

FIG. 3 is a diagram illustrating modules forming the vehicle. Hereinafter, the vehicle 200 among the plurality of vehicles will be mainly described, but the other vehicle 300 may also substantially include the following.

The vehicle 200 may be driven based on electrical energy or fossil energy. In the case of electrical energy, the vehicle 200 may be, for example, a pure battery-based vehicle that is driven only by a high-voltage battery or may be a vehicle with a gas-based fuel cell as an energy source. Furthermore, in the fuel cell, various types of gases configured for generating electrical energy, such as hydrogen, may be used, and a gas may be filled into the vehicle 200 in a liquefied state, for example. In the case of fossil energy, the vehicle 200 may be driven with a fuel such as gasoline, diesel, or liquefied gas, and may include an internal combustion engine that drives an actuating unit 214 through combustion of the fuel. The engine may be included in a power source unit 212 from the perspective of providing driving force to a wheel driving unit 216. As an exemplary embodiment of the present disclosure, in the vehicle 200, the actuating unit 214 may be driven by selectively utilizing energy from an internal combustion engine based on a fossil fuel and an electric battery, and the vehicle 200 may be a hybrid type vehicle.

The vehicle 200 may include a sensor unit 202, a manipulation unit 204, a display 206, a load device 208, and a transceiver unit 210.

The sensor unit 202 may include various types of detectors for detecting various states and situations that occur in an external environment, internal system, driving, user operation, and boarding space of the vehicle 200. The sensor unit 202 may also be called a sensor, which is a general term collectively referring to sensor modules included in the sensor unit 202.

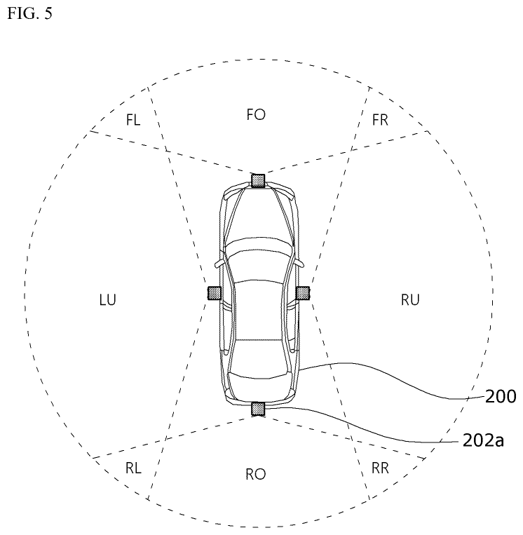

The sensor unit 202 may include an externally facing camera 202a, a Light Detection and Ranging (LiDAR) sensor 202b, a radio detection and ranging (RADAR) sensor 202c, and the like to recognize dynamic and static objects present outside the vehicle 200. The camera 202a may recognize an external object as an image during use of the vehicle 200 to generate image data and transmit the image data to a controller 220. As illustrated in FIG. 5, cameras 202a may be disposed on a plurality of parts of a vehicle body to be directed in different directions around the vehicle 200, thereby obtaining a surrounding environment. In an exemplary embodiment of the present disclosure, each camera may be referred to as an image channel. Accordingly, a surround view allowing an environment around the vehicle 200 to be recognized may be disposed. The LiDAR sensor 202b may be configured to generate point cloud data as recognition data for an external object and transmit the data to the controller 220 to generate three-dimensional spatial information for identifying at least the shape of the external object. The radio detection and ranging (RADAR) sensor 202c may emit radio waves at a specific frequency around the vehicle 200 and generate radio detection and ranging (RADAR) data through radio waves reflected from an external object, to ascertain, for example, the presence of the external object, and a relative distance, speed, and direction thereof. In an exemplary embodiment of the present disclosure, a case in which the LiDAR sensor 202b is disposed is illustrated, but in other examples, the LiDAR sensor 202b may not be disposed.

The sensor unit 202 may further include a positioning sensor 202d, a wheel sensor, and an attitude sensor. The positioning sensor 202d may be a module that identifies a position of the vehicle 200 and may include, for example, a Global Positioning System (GPS) sensor or a GNSS sensor. The wheel sensor may detect a speed of a wheel, rotation angle of the wheel, an angular velocity of the rotation of the wheel, an angle of a steering wheel, an angular velocity of rotation of the steering wheel, and the like. The attitude sensor may detect a three-axis state of the vehicle 200, such as yaw, pitch, and roll, and output various attitude states of the vehicle based on the above-described parameters. The attitude sensor may include, for example, an IMU sensor and a gyro sensor.

In an exemplary embodiment of the present disclosure, the sensors of the sensor unit 202 referred to in the description of the exemplary embodiment are mainly described, and sensors that detect various situations, which are not listed herein, may be additionally included.

The manipulation unit 204 may include a module for allowing the user to control the driving. For example, the manipulation unit 204 may be a steering wheel for manual driving, a directional automatic or manual shift actuator, an accelerator pedal, a brake pedal, a transmission, a turn indicator that signals a turning direction to nearby vehicles and pedestrians, and the like. The turn indicator may be disposed in hardware such as a lever or a button, or may be disposed as a user interface such as a soft key.

Furthermore, the manipulation unit 204 may further include an interface for use, release, and detailed function selection of an autonomous driving mode requested by the user, allowing the user to use an autonomous driving function. The manipulation unit 204 may include, for example, a hard type interface disposed at a predetermined position inside the vehicle 200 or a touchable soft type interface in the display 206 to receive various requests related to autonomous driving.

The display 206 may function as a user interface. The display 206 may output and display an operating status, a control status, route/traffic information, and remaining energy information (for example, remaining power information such as information on a remaining fuel amount and information on a remaining charge amount) of the vehicle 200, an image of a surrounding environment obtained from the camera 202a, content requested by the driver, and the like under control of the controller 220. The image of the surrounding environment may be a surround view from a camera with a specific view point or a plurality of cameras. Furthermore, the display 206 may be configured as a touch screen configured for detecting driver input to receive a driver's request to the controller 220.

The load device 208 may be disposed on the vehicle 200 and may be a type of non-driving electric device other than a driving power system such as the wheel driving unit 216. The load device 208 may be an auxiliary device that receives power from the power source unit 212, and may be, for example, an air conditioning system, a lighting system, a seat system, and various devices disposed on the vehicle 200.

The transceiver unit 210 may support mutual communication with the server 100, the ITS device 400, the nearby vehicle 300, and the like. The transceiver unit 210 may include, for example, a module for processing cellular communication, WAVE, DSRC communication, and the like. In an exemplary embodiment of the present disclosure, the transceiver unit 210 may transmit data generated or stored while driving to the server 100, and receive data and software modules transmitted from the server 100. The transceiver unit 210 may also support communication with an electronic device carried by a passenger inside the vehicle 200. In an exemplary embodiment of the present disclosure, the vehicle 200 may transmit and receive data utilized in the method according to an exemplary embodiment of the present disclosure to or from an external device through the transceiver unit 210.

Furthermore, the vehicle 200 may include the power source unit 212 and the actuating unit 214.

The power source unit 212 may be configured to generate and supply power and electric power used in a driving power system such as the actuating unit 214 and a non-driving power system. The non-driving power system may include, for example, the sensor unit 202, the manipulation unit 204, the display 206, the load device 208, and the transceiver unit 210. The non-driving power system is not limited thereto and may include various components that implement sensing, interface, communication, and convenience functions, other than components directly involved in a driving operation. When the vehicle 200 is driven with electrical energy, the power source unit 212 may include, for example, an electric battery charged from the outside thereof or configured as a combination of an electric battery and a fuel cell that charges the battery. When the vehicle 200 is driven with fossil energy, the power source unit 212 may include an internal combustion engine. Furthermore, when the vehicle 200 is a hybrid type, the power source unit 212 may be disposed as a combination of the internal combustion engine and the electric battery.

The actuating unit 214 includes at least one module that implements a driving operation, and may perform a driving operation of at least one of longitudinal control such as acceleration and deceleration and lateral control such as steering, in response to a user request from the manipulation unit 204. The actuating unit 214 may include the wheel driving unit 216, and a mechanical component and an electronic module for implementing a driving operation in the wheel driving unit 216, to perform a driving operation according to a command from the controller 220 in accordance with a manual operation of the user or autonomous driving. When the vehicle 200 is operated based on electrical energy, the actuating unit 214 may include an assembly for transmitting a requested driving operation to the wheel driving unit 216. When the vehicle 200 is operated based on fossil energy, the actuating unit 214 may include a transmission and a gear module for transmitting the power of the internal combustion engine.

The wheel driving unit 216 may include a plurality of wheels, a driving force generation module that generates driving force and applies or transmits the driving force to the wheels, a braking module that decelerates the driving of the wheels, and a steering module that realizes lateral control for the wheels. When the vehicle 200 is driven based on electrical energy, the driving force generation module may include a motor assembly that generates driving force based on power output from an electric battery. The braking module of the electric-based vehicle 200 may further include a regenerative braking function.

Furthermore, the vehicle 200 may include a storage unit 218 and a controller 220.

The storage unit 218 may store an application and various types of data for control of the vehicle 200, and may load the application or read or record the data upon request from the controller 220. In an exemplary embodiment of the present disclosure, the storage unit 218 may receive and manage the trained image processing model from the learning device 100. Furthermore, the storage unit 218 may manage respective channel images obtained from a plurality of cameras 202a, that is, a multi-channel image, in relation to the present disclosure. Furthermore, the storage unit 218 may receive and manage information necessary for driving, such as map information, traffic information, weather information, and accident information.

The controller 220 may perform overall control of the vehicle 200. The controller 220 of the vehicle 200 may be referred to as the processor of the vehicle 200 in an exemplary embodiment of the present disclosure. The controller 220 may be configured to execute applications and instructions stored in the storage unit 218. The controller 220 may be configured for processing a predetermined task related to an image obtained from a camera 204b using the image processing model stored in the storage unit 218. The controller 220 may be configured for controlling driving or the autonomous driving based on results or data output from the model. The controller 220 may execute the image processing model based on a multi-channel image having defects in some channel images in addition to a normal multi-channel image, thereby generating output data without performance degradation.

In an exemplary embodiment of the present disclosure, the controller 220 may be implemented as a single processing module, for example. In an exemplary embodiment of the present disclosure, processing according to the above-described matters may be distributed and processed in a plurality of processing modules, and the plurality of processing modules may be collectively referred to as the controller 220 in an exemplary embodiment of the present disclosure.

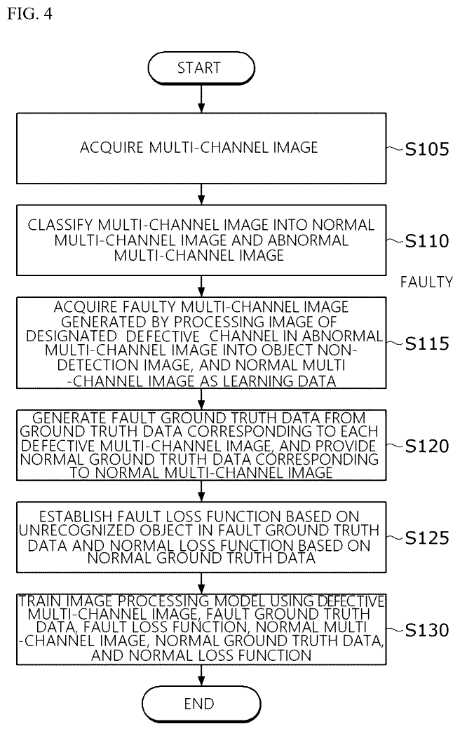

Hereinafter, a learning method for image processing for the defective multi-channel image according to another exemplary embodiment of the present disclosure will be described in detail with reference to FIG. 4. FIG. 4 is a flowchart of the learning method for image processing for the defective multi-channel image according to the other embodiment of the present disclosure.

In an exemplary embodiment of the present disclosure, a case in which the image processing model is trained only in a server configured as the learning device 100 will be mainly described, but a learning method for depth estimation to be described below may be distributed and processed in the learning device 100 and other devices as long as this does not conflict with the description below. The other devices may be, for example, other servers and/or the mobility apparatuses 200 and 300. Hereinafter, the processor 108 of the learning device 100 may be simply referred to as the learning device 100 for convenience of description, or these terms may be used interchangeably.

Referring to FIG. 4, the processor 108 of the learning device 100 may obtain the normal multi-channel image from the plurality of vehicles 200 and 300 (S105).

The multi-channel image may be a set of images obtained by the plurality of cameras, and each of the plurality of cameras may be referred to as an image channel. The normal multi-channel image may include at least one of a set of images obtained by respective normally operating cameras and a set of images in which there is no obstacle in identifying an object. As illustrated in FIG. 5, when the vehicle 200 includes four cameras 202a disposed thereon, the multi-channel image may include a set of images for four image channels. FIG. 5 is a diagram illustrating a view area in a multi-channel camera of the vehicle. According to the example of FIG. 5, images of the four channels may include images corresponding to shooting ranges of the respective image channels, that is, front images including front image FO, front left image FL, and front right image FR, rear images including rear image RO, rear left image RL, and rear right image RR, left images including left image LU, front left image FL, and rear left image RL, and right images including right image RU, front right image FR, and rear right image RR. Here, the multi-channel image may include overlapping image areas FL, FR, RL, and RR that overlap between adjacent channels.

Furthermore, the learning device 100 may obtain ground truth data corresponding to a result output from a task processed in the image processing model. An output result of the task may be, for example, at least one of a BEV, object classification information, semantic segmentation information, and depth estimation information. The ground truth data may be labeling data or reference data corresponding to the listed data. To train the image processing model, the ground truth data may be generated by an operator using the learning device 100 or may be obtained from an external device.

Next, the processor 108 of the learning device 100 may classify the multi-channel image as a normal multi-channel image or an abnormal multi-channel image (S110).

The normal multi-channel image may be an image set that is designated as the normal multi-channel image in the training of the image processing model. The abnormal multi-channel image may be an image set that is designated as the abnormal multi-channel image in the learning. The abnormal multi-channel image may be an image set that is to be processed to have defects in some of the image channels by virtually assuming that some of the image channels are operating abnormally or malfunctioning. The abnormal multi-channel image may be an image set that is to be processed to have defects in some of the image channels by virtually assuming that some of the channel images have significant obstacles in identifying objects. The images with significant obstacles may be images that cause an output with an error in processing of a task included in the image processing model or images from which an object cannot be detected. In other words, the abnormal multi-channel image may be an image set that is allocated to be processed as the defective multi-channel image in operation S115 to be described below.

The normal multi-channel image and the abnormal multi-channel image are classified in the same numbers, and the processor 108 may select the same number of normal and abnormal multi-channel images from the multi-channel images using a predetermined technique, such as a random probability scheme. In an exemplary embodiment of the present disclosure, a case in which the normal and abnormal multi-channel images are classified in the same number is illustrated, but the present disclosure is not limited thereto, and the normal and abnormal multi-channel images may be classified in different numbers according to a user's setting.

Next, the processor 108 may obtain the defective multi-channel image generated based on the normal multi-channel image and the abnormal multi-channel image as learning data (S115).

The normal multi-channel image may be a normal multi-channel image classified in operation S110 without being processed. The processor 108 may be configured to generate the defective multi-channel image by processing an image of a designated defective channel in the abnormal multi-channel image classified in operation S110 into an object non-detection image.

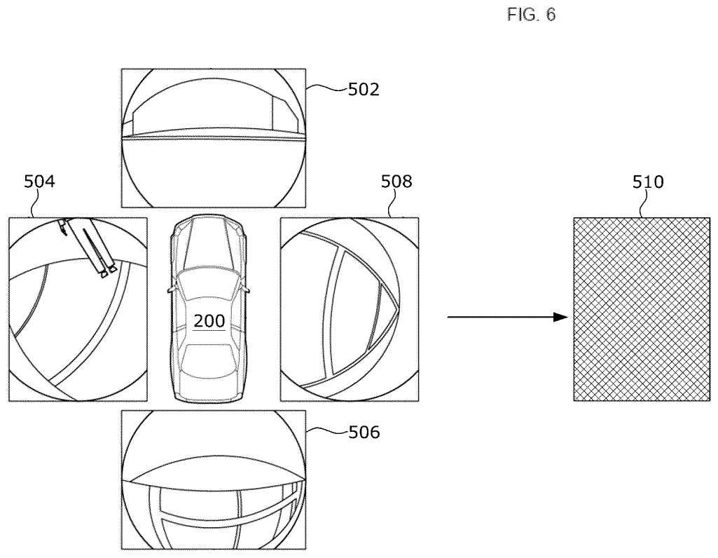

The defective channel may be an image channel related to at least one of a malfunctioning camera among the plurality of cameras and a channel image including a significant obstacle in identifying an object. As many defective channels as the plurality of cameras 202a, that is, the number of image channels, may be allocated. As illustrated in FIG. 6, when there are four image channels related to abnormal multi-channel images 502, 504, 506 and 508, there may be at least four cases including a defective channel. FIG. 6 is a diagram illustrating the defective multi-channel image. According to FIG. 6, one defective channel may be set for each of a front camera, a rear camera, a left camera, and a right camera. In an exemplary embodiment of the present disclosure, an example in which the defective channel is set as one of the plurality of image channels is illustrated, but in an exemplary embodiment of the present disclosure, when the defective channels are allowed to be set as some of the plurality of image channels, the defective channels may be designated as two or more channels at the same time.

The processor 108 may be configured for processing a channel image corresponding to a designated defective channel in the image set of the abnormal multi-channel image, that is, an image from a specific camera, into an object non-detection image. As illustrated in FIG. 6, when a right image channel (or a right camera) in the image set of the abnormal multi-channel image is designated as a defective channel, the processor 108 may be configured for processing a right channel image 508 of the right camera into an object non-detection image 510. Images 502, 504, and 506 of other image channels in the image set may be maintained without being processed. For the object non-detection image 510, the processor 108 may perform blackout processing on the right channel image 508 so that an object of the right channel image 508 cannot be identified. The processing for the object non-detection image 510 may be image masking as another example.

The processor 108 may designate an image channel other than the right image channel in another image set of the abnormal multi-channel image as a defective channel, and may be configured for processing a channel image corresponding to the designated defective channel into an object non-detection image, as in FIG. 6.

Each of a plurality of abnormal multi-channel images may be processed to have any one of a front channel image 502, a left channel image 504, a rear channel image 506, and a right channel image 508 as an image of the defective channel. For example, the processor 108 may be configured for processing the right channel image 508 of a first abnormal multi-channel image as the object non-detection image 510 to generate a first defective multi-channel image so that the image of the defective channel in the first abnormal multi-channel image is set as the right channel image 508. The processor 108 may be configured for processing the front channel image 502 of a second abnormal multi-channel image as the object non-detection image to generate a second defective multi-channel image so that the image of the defective channel in the second abnormal multi-channel image is set as the front channel image 502.

The processor 108 may equally generate the defective multi-channel image for each of the plurality of image channels. For example, in FIG. 6, when there are 4n abnormal multi-channel images, n defective multi-channel images for each of the front image channel, the rear image channel, the left image channel, and the right image channel may be generated. The processor 108 may allocate the same number of defective multi-channel image for each image channel as the abnormal multi-channel images using a predetermined technique such as a random probability scheme. The present disclosure illustrates that the same number of defective multi-channel images are allocated for each image channel. However, the present disclosure is not limited thereto, and the defective multi-channel images of at least one image channel may be allocated in a different number from the defective multi-channel images of other channels depending on a user's setting.

Next, referring back to FIG. 4, the processor 108 may be configured to generate fault ground truth data from the ground truth data corresponding to each defective multi-channel image, and provide normal ground truth data corresponding to the normal multi-channel image and the fault ground truth data as ground truth data for learning (S120).

With the fault ground truth data, normal ground truth data corresponding to the defective multi-channel image may be processed based on the defective channel identified in each defective multi-channel image. The processor 108 may be configured to generate fault ground truth data by processing some ground truth data corresponding to a unique image area of the defective channel into an unrecognized state. The unique image area may be a non-overlapping image area recognized only in the defective channel other than an overlapping image area between the defective channel and the normal channel adjacent to the defective channel.

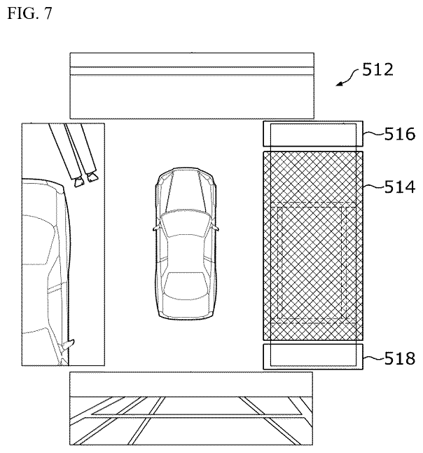

FIG. 7 is a diagram illustrating an example in which the fault ground truth data is generated. In FIG. 7, a BEV is shown as a task output, that is, ground truth data in the image processing model, and a case in which fault ground truth data is generated based on the BEV is illustrated. The BEV in FIG. 7 may be a portion of an image obtained by the multi-channel image illustrated in FIG. 6 being processed by the BEV network. The defective multi-channel image in FIG. 6 is an image in which the left image channel is a defective channel, and the fault ground truth data generated from the defective multi-channel image in FIG. 6 is illustrated in FIG. 7. The processor 108 may identify the right image channel as the defective channel in the defective multi-channel image of FIG. 6, and determine an image area, a unique image area, and an overlapping image area of the normal channel from the normal ground truth data illustrated in FIG. 7 based on the defective channel. When the right image channel is the defective channel, the processor 108 can identify, from the normal ground truth data of FIG. 7, a unique image area (514 corresponding to RU of FIG. 5) and overlapping image areas (516 and 518 corresponding to FR and RR of FIG. 5) of the right image channel. In the present example, the overlapping image areas 516 and 518 may be overlapping areas between the right image channel and normal channels (a front image channel and a rear image channel) adjacent to the right image channel. Referring to FIG. 7, the processor 108 may be configured for processing some ground truth data corresponding to the unique image area 514 into an unrecognized state to generate fault ground truth data 512. The fault ground truth data may be generated by dark processing for the ground truth data corresponding to the unique image area 514. The overlapping image areas 516 and 518 may be processed as a BEV based on the normal channels, that is, the front image channel and the rear image channel.

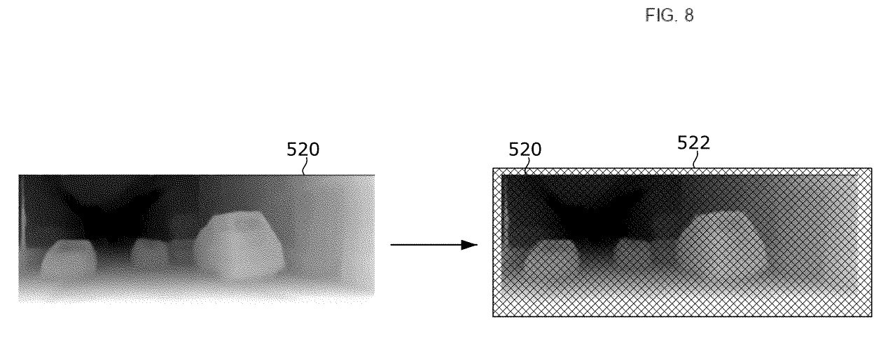

Furthermore, when the image processing model includes a depth estimation network, the fault ground truth data may be generated by masking processing for setting a depth value in the ground truth data corresponding to the unique image area to null. FIG. 8 is a diagram illustrating another example in which the fault ground truth data is generated. According to the above example, the unique image area (520 corresponding to RU in FIG. 5) of the right image channel corresponding to the defective channel may be processed to include a null value by masking processing 522. The overlapping image area may be processed with an estimated depth based on the normal channel, that is, the front image channel and the rear image channel.

As an exemplary embodiment of the present disclosure, when the image processing model includes a network according to object classification or semantic segmentation, the fault ground truth data may be generated by processing the ground truth data corresponding to the unique image area into an unrecognized state, similar to the above. For the unrecognition processing, for example, dark processing or null mask processing may be used.

Next, referring back to FIG. 4, the processor 108 may establish a fault loss function based on an unrecognized object in the fault ground truth data and a normal loss function based on the normal ground truth data to prepare loss functions for training of the image processing model (S125).

The fault loss function may be established as a loss function that excludes an object belonging to the normal ground truth data corresponding to the unique image area and considers an object belonging to the ground truth data corresponding to an image area of the normal channel.

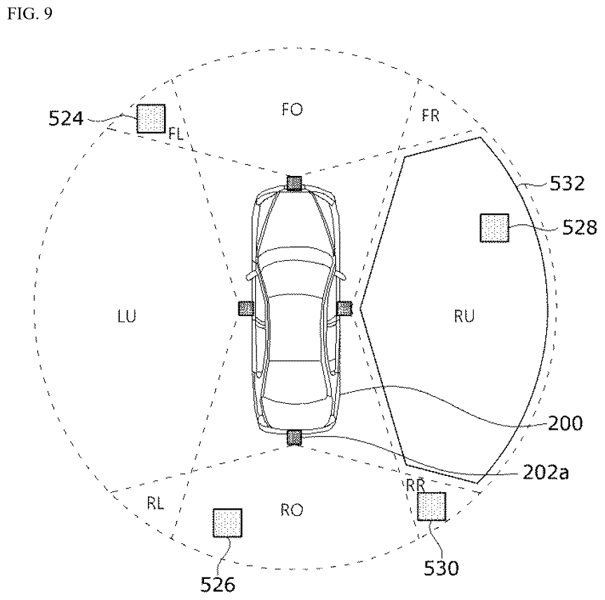

Referring to the example of FIG. 7, the processor 108 may analyze the fault ground truth data 512 prior to the unrecognition processing to identify the unique image area 514 and configure a loss function in which objects belonging to the overlapping image areas 516 and 518 and the image area of the normal channel, other than objects belonging to the unique image area 514, are considered. Referring to FIG. 9, which is illustrated from another perspective, the processor 108 may identify an object 528 belonging to a unique image area (RU) 532 of right channel images RO, FR, and RR, and identify objects 524, 526, and 530 belonging to the overlapping image areas FR and RR and image areas FO, RO, FR, RR, LU, FL, and RL of the normal channel. FIG. 9 is a diagram illustrating an object belonging to the unique image area of the defective channel.

When the identified objects, that is, the object 524, the object 526, the object 528, and the object 530, are obj1, obj2, obj3, and obj4, respectively, the fault loss function may be established as in Equation 1. Since a weight of the object 528 belonging to the normal ground truth data corresponding to the unique image area 532 is 0, the fault loss function can be formed with a factor due to the object 528 being excluded. The fault loss function for each defective channel may be provided according to the above-described matters. Furthermore, the fault loss function and the normal loss function may be provided for each network of each task.

$$L = {λ}_{1} \cdot {L}_{obj 1} + {λ}_{2} \cdot {L}_{obj 2} + {λ}_{3} \cdot {L}_{obj 3} + {λ}_{4} \cdot {L}_{obj 4} \\ where {λ}_{1} = {λ}_{2} = {λ}_{4} = 1 and {λ}_{3} = 0 . \qquad [ Equation 1 ]$$

Referring back to FIG. 4, the processor 108 of the learning device 100 may train the image processing model using input data for learning, ground truth data for learning, and a loss function for learning (S130).

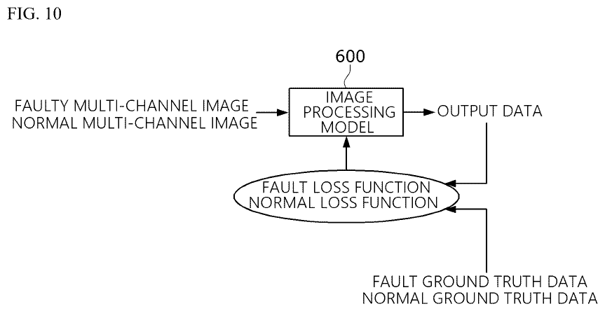

FIG. 10 is a diagram illustrating the training of the image processing model. The input data for learning may include a normal multi-channel image and a defective multi-channel image. The ground truth data for learning may include the normal ground truth data and the fault ground truth data. The loss function for learning may include a normal loss function and a fault loss function. An image processing model 600 may be trained based on the fault ground truth data and the fault loss function when the defective multi-channel image is input. In the case of training based on the defective multi-channel image, the processor 108 may train the image processing model related to the defective multi-channel image by use of the overlapping image area obtained through the normal channel adjacent to the defective channel. The image processing model 600 may be trained based on the normal ground truth data and the normal loss function when the normal multi-channel image is input.

After the training is completed, the processor 108 may distribute (or transmit) the image processing model to the vehicles 200 and 300. Even when the defective multi-channel image is input, the vehicles 200 and 300 can output a task result with no distortion or performance degradation by excluding the unique image area of the defective channel and using the overlapping image area and the image area of the normal channel in the image processing model 600.

According to an exemplary embodiment of the present disclosure, it is possible to provide a learning method and device for image processing that guarantees output stability of a learning-based image processing model without performance degradation even based on a multi-channel image including some defects.

Furthermore, since an additional network module is not used for the image processing model, the execution latency of the image processing model cannot be increased when the multi-channel image including some defects is processed.

The effects that can be obtained from the present disclosure are not limited to the effects mentioned above, and other effects that are not mentioned can be clearly understood by those skilled in the art from the description below.

While the exemplary methods of the present disclosure described above are represented as a series of operations for clarity of description, it is not intended to limit the order in which the steps are performed, and the steps may be performed simultaneously or in different order as necessary. To implement the method according to an exemplary embodiment of the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

Furthermore, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

What is claimed is:

1. A learning method for image processing for a defective multi-channel image, the learning method comprising:
obtaining, by a processor, the defective multi-channel image and a normal multi-channel image as learning data from a multi-channel image obtained from a vehicle;
identifying, by the processor, a defective channel of the defective multi-channel image to generate fault ground truth data from ground truth data corresponding to the defective multi-channel image, and provide normal ground truth data corresponding to the normal multi-channel image;
training, by the processor, an image processing model using the learning data, the fault ground truth data, and the normal ground truth data;
transmitting, by the processor, the image processing model to the vehicle; and
controlling, by a processor of the vehicle, the vehicle based on data output from the image processing model executed by the processor of the vehicle.

2. The learning method of claim 1, wherein the defective multi-channel image is generated by processing, into an object non-detection image, an image designated as a defective channel among image channels of an abnormal multi-channel image selected from the multi-channel image.

3. The learning method of claim 2, wherein the multi-channel image is a set of images obtained from image channels set for a plurality of cameras disposed on the vehicle, and the defective channel is designated as one of a plurality of image channels.

4. The learning method of claim 3, wherein the normal multi-channel image and the defective multi-channel image are classified through equal distribution of the multi-channel image, and the defective multi-channel image is generated equally for the plurality of image channels.

5. The learning method of claim 2, wherein the defective multi-channel image is generated by blackout processing for an image of the defective channel in the abnormal multi-channel image.

6. The learning method of claim 1,
wherein the fault ground truth data is generated by processing the ground truth data corresponding to a unique image area of the defective channel into an unrecognized state, and
wherein the unique image area is a non-overlapping image area recognized only in the defective channel other than an overlapping image area between the defective channel and a normal channel adjacent to the defective channel.

7. The learning method of claim 6, wherein the fault ground truth data is generated by blackout processing for the ground truth data corresponding to the unique image area.

8. The learning method of claim 6, wherein, based on that the image processing model includes depth estimation, the fault ground truth data is generated by masking processing for setting a depth value to null in the ground truth data corresponding to the unique image area.

9. The learning method of claim 6,
wherein the training of the image processing model includes training the image processing model using a fault loss function related to the fault ground truth data and a normal loss function related to the normal ground truth data, and
wherein the fault loss function is established as a loss function in which an object belonging to the ground truth data corresponding to the unique image area is excluded and an object belonging to the ground truth data corresponding to an image area of the normal channel is considered.

10. The learning method of claim 6, wherein the training of the image processing model includes processing learning for the defective multi-channel image using the overlapping image area obtained through the normal channel adjacent to the defective channel.

11. A learning apparatus for image processing for a defective multi-channel image, the learning apparatus comprising:
a memory storing at least one instruction; and
a processor configured to execute the at least one instruction stored in the memory, wherein the processor, by executing the at least one instruction,
obtains the defective multi-channel image and a normal multi-channel image as learning data from a multi-channel image obtained from a vehicle;
identifies a defective channel of the defective multi-channel image to generate fault ground truth data from ground truth data corresponding to the defective multi-channel image, and provides normal ground truth data corresponding to the normal multi-channel image;
trains an image processing model using the learning data, the fault ground truth data, and the normal ground truth data; and
transmits the image processing model to the vehicle,
wherein the image processing model is executed by a processor of the vehicle, and the vehicle is controlled based on data output from the image processing model executed by the processor of the vehicle.

12. The learning apparatus of claim 11, wherein the processor of the learning apparatus generates the defective multi-channel image by processing, into an object non-detection image, an image designated as a defective channel among image channels of an abnormal multi-channel image selected from the multi-channel image.

13. The learning apparatus of claim 12, wherein the multi-channel image is a set of images obtained from image channels set for a plurality of cameras disposed on the vehicle, and the defective channel is designated as one of a plurality of image channels.

14. The learning apparatus of claim 13, wherein the normal multi-channel image and the defective multi-channel image are classified through equal distribution of the multi-channel image, and the defective multi-channel image is generated equally for the plurality of image channels.

15. The learning apparatus of claim 12, wherein the processor of the learning apparatus generates the defective multi-channel image blackout processing for an image of the defective channel in the abnormal multi-channel image.

16. The learning apparatus of claim 11,
wherein the processor of the learning apparatus generates the fault ground truth data by processing the ground truth data corresponding to a unique image area of the defective channel into an unrecognized state, and
wherein the unique image area is a non-overlapping image area recognized only in the defective channel other than an overlapping image area between the defective channel and a normal channel adjacent to the defective channel.

17. The learning apparatus of claim 16, wherein the processor of the learning apparatus generates the fault ground truth data by blackout processing for the ground truth data corresponding to the unique image area.

18. The learning apparatus of claim 16, wherein, based on that the image processing model includes depth estimation, the processor of the learning apparatus generates the fault ground truth data by masking processing for setting a depth value to null in the ground truth data corresponding to the unique image area.

19. The learning apparatus of claim 16,
wherein the training of the image processing model includes training the image processing model using a fault loss function related to the fault ground truth data and a normal loss function related to the normal ground truth data, and
wherein the fault loss function is established as a loss function in which an object belonging to the ground truth data corresponding to the unique image area is excluded and an object belonging to the ground truth data corresponding to an image area of the normal channel is considered.

20. The learning apparatus of claim 16, wherein the training of the image processing model includes processing learning for the defective multi-channel image using the overlapping image area obtained through the normal channel adjacent to the defective channel.
